(19) United States
(12) Patent Application Publication
(10) Pub. No.: US 2020/0218067 A1
(43) Pub. Date: Jul. 9, 2020

(54) Mirror Device

(71) Applicant: JENOPTIK Optical Systems GmbH, Jena (DE)

(72) Inventor: Jan WERSCHNIK, Jena (DE)

(21) Appl. No.: 16/622,896

(22) PCT Filed: Jun. 4, 2018
(86) PCT No.: PCT/DE2018/100531

§ 371 Date: Dec. 13, 2019

(30) Foreign Application Priority Data
Jun. 29, 2017 (DE) 10 2017 114 502.8

(51) Int. Cl. G02B 27/01; G02B 27/32; A45D 42/00; A45D 44/00; A47G 1/00

(52) U.S. Cl. CPC G02B 27/0101; G02B 27/32; A45D 42/00; A45D 44/005; A47G 2001/002; G02B 2027/0118; G02B 2027/0138; A47G 2001/007; A47G 1/00

(57) ABSTRACT

The invention relates to a mirror device for simultaneously viewing one's own mirror image and additional information. The mirror device comprises a mirror (2) which is partially permeable to visible light, and an optical system (3) which is arranged on a side of the partially permeable mirror (2) facing away from the viewer (1) and which images an electronic display (3.1) enlarged by a lens (3.2) into an intermediate image plane (ZBE) that appears to be at a same distance from the viewer as his or her mirror image.

### RELATED APPLICATIONS

This application is a National Phase Application of International Application PCT/DE2018/100531, filed on Jun. 4, 2018, which in turn claims priority to German Patent Application DE 10 2017 114 502.8, filed Jun. 29, 2017, both of which are incorporated herein by reference in their entirety.

### FIELD OF THE INVENTION

The visual provision of digital information currently takes place on a variety of electronic displays, e.g. on laptops, tablets, mobile phones or stationary fixed screens. In order to capture the information displayed, the viewer's eyes accommodate on the surface of the display.

### BACKGROUND OF THE INVENTION

In the state of the art, so-called mirror displays are now also known, in which the viewer (hereinafter also referred to as the user) can, on the one hand, view himself or herself and, on the other hand, read digital information. A mirror display with controllable information display areas is known from US 2014/0085178 A1. It comprises a mirror with a reflective viewer side and a reverse side facing away from the reflective viewer side, on which reverse side an LCD display is arranged. The information display areas that can be controlled on the LCD display are visible to the viewer through the mirror.

US 2016/0080527 A1 proposes a comparable device, which is a combination of a mirror and an electronic display.

WO 2013/075082 A1 describes the idea of an interactive, data-carrying mirror interface. This idea is based on the assumption that the displays of conventional mobile devices, which are used to make digital data available in line with trends, will tend to become smaller, which is why the information that can be displayed at the same time is limited. Also, the possibilities of user interaction with such devices are limited.

The mirror interface proposed here comprises a so-called mirror display, a sensor which is designed to receive input from the user, and a processor which is connected to the sensor via a data link. The processor is configured to identify the user, retrieve user-specific information, and interact with the user. For this purpose, the processor has a voice processor and a video processor, as well as an output which is designed to display the content associated with the user identification and, as a result, the interactions on the mirror surface of the mirror display. In different embodiments, the mirror display is designed to have a partially transparent glass surface in order to be able to view normal reflection as well as high-contrast graphics with superimposition. The mirror image can be viewed in the areas where the display, e.g. an LCD panel, is dark or when the display is off. The above-mentioned WO 2013/075082 A1 discloses a multitude of possible interactions by which the mirror interface can interact with the user e.g. via voice commands, gestures and face recognition. It also mentions all kinds of conceivable information interesting a user, which can be displayed user-specifically or also unspecifically.

All so-called mirror displays have the disadvantage that the user does not see his or her own mirror image and the displayed data at the same distance, which is why the eyes must constantly alternate between accommodating to the distance from the mirror for viewing the displayed information and accommodating to twice that distance for viewing his or her own mirror image. Both the information displayed on the mirror surface and the viewer's own mirror image can only be seen sharply at approximately the same time if the viewer stands at a great distance in front of the mirror, at which he or she no longer perceives at least the mirror image as a still sufficiently comfortable size.

### SUMMARY OF THE INVENTION

The object of the invention is to provide a mirror device allowing a to simultaneously see his or her mirror image and additional information sharply.

This object is achieved by a mirror device according to claim 1 for simultaneously viewing one's own mirror image and additional information with the eyes of a viewer positioned in front of the mirror device, said device comprising a mirror which is partially permeable to visible light and an electronic display arranged on a side of the mirror facing away from the viewer, in that the electronic display is part of an optical system which is arranged entirely on the side of the mirror facing away from the viewer and further comprises a lens which is arranged along an optical axis and comprises a first objective, a second objective, an aperture stop and a deflecting element. The electronic display is imaged via the first objective into an intermediate image plane, which is imaged via the second objective, the deflection element and the lenses of the eyes or only via the deflection element and the lenses of the eyes on their retina. The intermediate image plane may be located, in the direction of the viewer, in front of, in or behind the second objective and is located in a conjugated plane to a plane in which the virtual mirror image of the viewer forms. The mirror image and the information thus appear to the viewer to be located at the same distance to which the eyes accommodate. The second objective, in particular, magnifies the aperture stop into a plane in front of, in or behind the eyes.

The pupils of the eyes preferably lie in this plane, so that the information is imaged on the retina of the eyes without a marginal light drop. The image of the aperture stop is at least large enough for the pupils of the eyes to lie within an image of the aperture stop. The size of the aperture stop image determines how large the range is within which the viewer can deviate from the given viewer position and still perceive the information with the same brightness.

Advantageously, the viewer position is advantageously determined by three position sizes, namely the vertical distance of the eyes to the mirror as well as a vertical distance and a horizontal distance of the eyes from an imaginary fixed point on the partially permeable mirror.

Furthermore, it is advantageous if the electronic display is arranged within the focal length of the first objective, so that the intermediate image plane is a virtual intermediate image plane.

Preferably a first adjustment unit connected to the first objective and the second objective is provided and preferably the first objective and the second objective are adjustable so that the intermediate image plane and the aperture stop are displaceable along the optical axis to adjust the position of the intermediate image plane and the aperture stop to a change of the vertical distance of the viewer position.

It is also advantageous if there is a second adjustment unit connected to the deflecting element and the deflecting element is adjustable to adapt the position of a penetration point of the optical axis through the mirror and/or an angular position of the optical axis to a perpendicular to the partially permeable mirror to a change in the horizontal distance and/or the vertical distance of the viewer position.

Advantageously, there is at least one sensor for determining the vertical distance and a computing and control unit which are connected to the at least one sensor and the first adjustment unit in order to control the first adjustment unit as a function of the detected signals of the at least one sensor.

It is advantageous to have at least one further sensor for determining the vertical distance and/or the horizontal distance, which sensor is connected to the computing and control unit and the second adjustment unit in order to control the second adjustment unit as a function of the detected signals of the at least one further sensor.

Preferably, the optical system is arranged centrally to the mirror in such a way that the optical axis extends vertically up to the deflecting element.

Preferably, the deflecting element is vertically displaceable and/or tiltable about a horizontal axis in order to move the penetration point of the optical axis vertically and/or adjust the angular position of the optical axis vertically.

It is furthermore advantageous if the mirror has at least one mark indicating its center, so that the viewer, and thus the eyes of the viewer, guided by the at least one mark in front of the mirror, position themselves centrally in front of the mirror in relation to the horizontal distance.

It is advantageous if the mirror device is mounted vertically suspended and there is a third adjustment unit by which the mirror device can be moved vertically.

Preferably, the mirror has at least one mark indicating a fixed vertical distance from an upper or lower edge of the mirror so that the viewer, guided by the at least one mark, can adjust the mirror device vertically to position his or her eyes in front of the mirror at the vertical distance regardless of the viewer's size.

It is advantageous to have a brightness sensor which detects the brightness of the ambient light and is connected to the electronic display to control its radiation intensity.

In addition, it is advantageous if a second identical optical system is present and the intermediate image, reproduced together with a second intermediate image in the eyes, provides a 3D image of the information.

### BRIEF DESCRIPTION OF THE DRAWINGS

The invention will be explained in more detail below with reference to exemplary embodiments and drawings.

In the drawings:

FIGS. 1A and 1B show a schematic diagram of a mirror device according to the invention and a viewer positioned in front of it in two different views,

FIG. 2A shows the optical system with a real intermediate image plane, and

FIG. 2B shows the optical system with a virtual intermediate image plane.

### DETAILED DESCRIPTION OF THE PREFERRED EMBODIMENTS

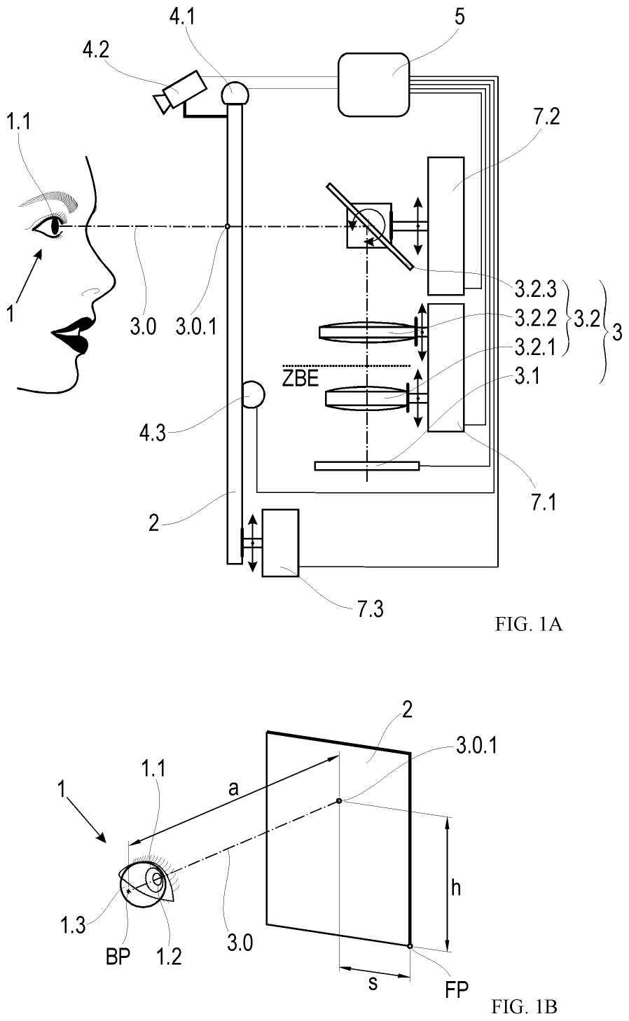

A mirror device according to the invention is formed, as shown in principle in FIGS. 1A and 1B, by at least one the mirror 2, which is partially permeable to visible light, and an optical system 3 arranged behind the mirror 2, which optical system 3 substantially comprises an electronic display 3.1 and a lens 3.2. The lens 3.2 comprises a first objective 3.2.1, a second objective 3.2.2, an aperture stop AP and a deflection element 3.2.3 arranged along an optical axis 3.0.

On each retina 1.3 of the eyes 1 of a viewer standing in front of the mirror device, the mirror image of the viewer and information displayed on the electronic display 3.1 are simultaneously sharply displayed when the viewer looks into the mirror 2. This is made possible by the electronic display 3.1 using the first objective 3.2.1 to create an intermediate image 3.1′ at an apparent distance from the eyes 1 of the viewer, at which the virtual mirror image of the viewer is also created, and reproducing said intermediate image 3.1′ on the retina 1.3 of each eye 1. The mirror image and the intermediate image 3.1′ are in conjugated planes. The virtual mirror image of the viewer 1 is created at a distance from the eyes 1 equal to twice the distance a of the eyes 1 from the mirror 2 in the viewing direction. For a clear description of the invention, it will be assumed that the viewer sees the information when looking straight ahead and thus the distance a equals a vertical distance of the eyes 1 from the mirror 2. Also, for the sake of simplicity, the distance from the eyes 1 is equated here to the distance from the viewer and the distance from the retina 1.3 of the eyes 1. The second objective 3.2.2 magnifies the aperture stop AP into a plane in which the eyes 1 are in a viewer position BP. This means that the eyes 1, more precisely the pupils 1.2, are in a conjugated plane to the plane in which the aperture stop AP is located. The magnification of the second objective 3.2.2 is greater than 1:1 and results in an enlarged image of the aperture stop AP′, within which at least both pupils 1.2 can be arranged. Preferably the magnification is so strong that the eyes 1 and thus the viewer can move back and forth within a range of movement in front of the mirror 2, as is usual when viewing oneself in a mirror.

Due to the fact that an image of the electronic display 3.1 is viewed, rather than viewing the latter directly, it is preferably presented to the eyes 1 magnified according to the magnification of the lens 3.2. This allows the electronic display 3.1 itself to be kept small, which has a positive effect on its price and the space it requires.

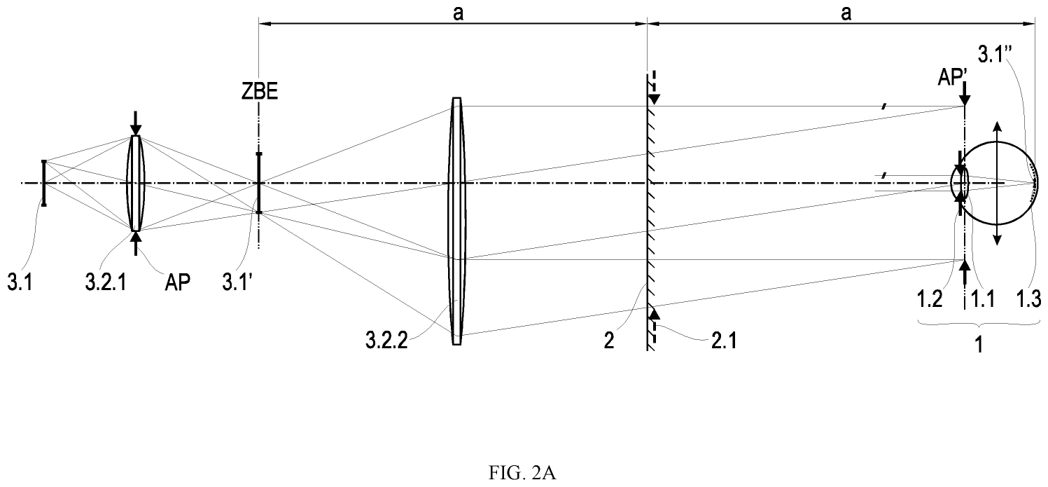

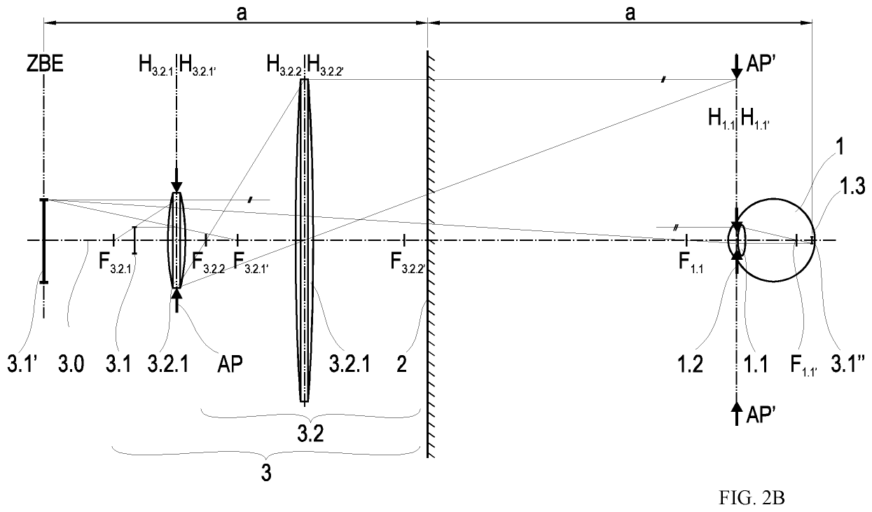

The intermediate image 3.1′ can be reproduced in a real intermediate image plane ZBE—see FIG. 2A—or in a virtual intermediate image plane ZBE—see FIG. 2B. By advantageously reproducing the intermediate image 3.1′ in a virtual intermediate image plane ZBE as a virtual intermediate image 3.1′, the overall length of the optical system 3 can be kept short, so that no elements folding the imaging beam path of the optical system 3 are required to place the optical system 3 completely behind the partially permeable the mirror 2, provided the latter does not fall below the usual dimensions, e.g. of a typical wall mirror.

In order to be able to see a mirror image and information at all, the mirror 2 is partially permeable to visible light, i.e. it is partially reflecting and partially transmitting for visible light. Thus, a mirror image can be reflected and an intermediate image 3.1′ of the electronic display 3.1 can be transmitted. The mirror 2 does not have to be partially permeable over its entire extent, but basically only via at least one free aperture 2.1, which does not crop an image of the aperture stop AP. For example, the mirror 2, could also be fully mirror-coated on one half of the mirror, so that the viewer, as in front of a conventional mirror, can view his or her mirror image with a comparatively high contrast. In this case, the viewer must stand in front of the other half of the mirror in order to be able to see the information at the same time as the low-contrast mirror image.

A mirror device according to the invention can be embodied in such a way that it is designed for a certain viewer position BP, i.e. the eyes 1 of the viewer must be brought into a certain position to the mirror 2 in order to be able to see the information optimally.

This simplest version of a mirror device is suitable for a hand mirror or a height-adjustable wall mirror if one can assume that the viewer positions his or her eyes 1 centrally in front of the mirror 2.

If the viewer is to be able to stand at different distances in front of the mirror 2, the optical system 3 can be adapted to the change in the viewer position BP.

The relative viewer position BP is determined by three position variables, namely the vertical distance a of the eyes 1 from the mirror 2 as well as a vertical distance h and a horizontal distance s of the eyes 1 with respect to a fixed point FP on the mirror 2.

The eyes 1 are then exactly in the viewer position BP and lie on the optical axis 3.0, as simplified below, if the optical axis 3.0 extends in a plane of the pupils 1.2, centrally between the pupils 1.2 or, in other words, centrally crosses the eye line. In practice, the position of the eyes 1 can deviate from the viewer position BP within a given range of movement. This range of movement is limited by the size of the image of the aperture stop AP′.

The viewer position BP is a fixed position if the viewer, regardless of what person the viewer is, is positioned at an equal vertical distance a in front of the mirror 2 and the eyes 1 are at an equal vertical distance h and at an equal horizontal distance s from the fixed point FP on the mirror 2.

With regard to an equal vertical distance a and an equal horizontal distance s, the viewer can be given instructions which he or she must follow. In order to always set the same vertical distance h for the viewer, regardless of the viewer's body height, the mirror device is preferably height-adjustable if it is mounted at a fixed location.

Basically, the mirror device does not have to be mounted at a fixed location.

If the mirror device is designed in such a way that the viewer does not necessarily always have to stand at the same vertical distance a in front of the mirror device—different people have different habits as viewers here—the lens 3.2 can be adjusted. Adjustable means that the focal length of the first objective 3.2.1 and/or the focal length of the second objective 3.2.2 can be varied by the lens 3.2 being designed in each case as a multi-lens system with lenses displaceable relative to one another and/or the first objective 3.2.1 and/or the second objective 3.2.2 being displaceable along the optical axis 3.0 of the optical system 3. Thus, along the optical axis 3.0, the apparent distance of the intermediate image plane ZBE, in which the intermediate image 3.1′ of the electronic display 3.1 forms, can be changed towards the eyes 1 of the viewer, with the aperture stop AP always being reproduced in the plane of the pupils 1.2. The displacement paths required for this are determined by a computation and control unit 5 with knowledge of the vertical distance a from the mirror 2.

In the case of a variable vertical distance a of the viewer it is advantageous if at least one sensor 4.1 is present from whose measured values the vertical distance a of the viewer to the mirror 2 is determined. The measured values are transmitted to the computation and control unit 5, which is connected to a first adjustment unit 7.1 connected to the lens 3.2. The computation and control unit 5 converts the measured values correlating to the vertical distance a into an adjustment path for the lens 3.2 and controls the first adjustment unit 7.1 in order to shift the displaceable intermediate image plane ZBE to the double vertical distance a from the eyes 1 of the viewer, while maintaining the aperture stop AP in a plane conjugated to the pupils 1.2.

Strictly speaking, the vertical distance a of the eyes 1 from the mirror 2 corresponds exactly to half the distance at which the viewer's mirror image appears to the viewer only if his or her viewing direction is perpendicular to the surface of the mirror 2 in a straight view. Deviations of the distance of the mirror image from the double vertical distance a, which arise when a picture 3.1″ in the eyes 1 results from a deviation of the viewing direction from the straight viewing direction, shall be neglected here, especially since they are small in comparison to the distance.

The shorter the vertical distance a is, the more accurate the alignment of the optical axis 3.0 relative to the eyes 1, by the specific positioning of the viewer in front of the mirror 2 or by the adjustment of the deflection element 3.2.3 and by the adjustment of the optical distance between the intermediate image 3.1′ and the eyes 1 has to be. Conversely, this means that the further away the viewer is from the mirror 2, the more the optical distance between the intermediate image 3.1′ and the eyes 1 may deviate from the distance of the virtual mirror image from the eyes 1, without the viewer having to accommodate, which is why a vertical distance a can practically also be assumed, even if the information is not seen positioned centrally when the viewing direction is straight ahead and the viewing direction encloses a small acute angle with the perpendicular to the mirror 2.

In order for the eyes 1 and the optical axis 3.0 emerging from the mirror 2 to assume the required relative position to each other, i.e. the eyes 1 assume the viewer position BP, it is possible either to give the viewer instructions in order to position themselves accordingly, or to adjust the optical system 3 to an arbitrary viewer position BP in front of the mirror 2.

The technically simpler and therefore more cost-effective solution for a mirror device is that the mirror device is preset to a certain viewer position BP and the viewer is given instructions where he or she has to position himself or herself in front of the mirror device.

Assuming that the viewer preferably stands centrally in front of the mirror 2 and wishes to look at his or her mirror image standing or sitting starting from the top of his or her head downwards, the optical system 3 and in particular the deflecting element 3.2.3 are preferably arranged behind the statically fixed the mirror 2 in such a way that a penetration point 3.0.1 of the optical axis 3.0 lies centrally in the horizontal direction and in the vertical direction in the upper half of the mirror 2, the optical axis 3.0 passing perpendicularly through the mirror 2. The eyes 1 are then on the optical axis 3.0, irrespective of the viewer's distance from the mirror 2, when the mirror image of the eyes 1 covers the penetration point 3.0.1. In order to achieve this relative position, marks are preferably provided on the mirror 2. These can be, for example, direction arrows whose directions intersect at a vertical distance h and horizontal distance s from the fixed point FP, or any symbols or characters that overlap or border the imaginary intersection point. The viewer then positions himself or herself in front of the mirror 2 in such a way that, for example, an arrow is directed to the longitudinal axis of the body in the mirror image of the viewer, or the symbol lies on the longitudinal axis of the body in the mirror image of the viewer 1, whereby a certain viewer position BP is assumed in relation to the horizontal distance s. In order to bring the eyes 1 to the height of the penetration point 3.0.1, the height of the mirror device can be adjusted so that the viewer, independent of his or her size, perceives, for example, the arrow at the lateral edge or the symbol at the level of the eye line when looking straight ahead, and assumes the viewer position BP in relation to the specified vertical distance h. In a preferably simple solution, the mirror device can be moved and fixed to the wall on vertically aligned guide rails.

The viewer's eyes 1 then assume the same relative position to the mirror 2, determined by the penetration point 3.0.1, regardless of what kind of person the viewer is and regardless of the moment of viewing, without having to accept restrictions for persons of different sizes.

Later, when the viewer looks at his or her mirror image and information, he or she will no longer perceive the marks on the mirror 2 as they are not in the depth of field of the eyes 1 accommodated on the mirror image.

The technically more complex solution for a mirror device, so that the optical axis 3.0 hits the eyes 1, consists in the deflection of the optical axis 3.0 into the eyes 1 via the displacement and/or tilting of the deflection element 3.2.3.

With such a solution, the viewer can arbitrarily position himself or herself in front of the mirror 2. Although one can assume in approximation that he or she stands centrally in front of the mirror 2, so that the penetration point 3.0.1 correctly lies on a center line of the mirror 2, the relative height level of the eyes 1 is completely unknown. In this case the mirror device has at least one further sensor 4.2, e.g. a camera, to determine the position of the eyes 1. The deflecting element 3.2.3 can be moved and/or tilted in order to deflect the optical axis 3.0, and thus the imaging beam path coming from the intermediate image 3.1′, into the eyes 1.

In order to adapt the intensity with which the electronic display 3.1 emits visible light to the prevailing ambient light, the mirror device advantageously features a brightness sensor 4.3 whose output signals control the power consumption of the electronic display 3.1 and thus the intensity of the light.

The mirror device according to the invention enables a three-dimensional representation of information. By duplicating the described optical system 3 and, if necessary, the first and second adjustment units 7.1, 7.2, whereby the computation and control unit 5, if applicable, and the sensors 4.1, 4.2 only have to be present once, the then two electronic displays 3.1 can be used to generate different representations of the same information, which are linked by the brain to form a 3D image, so that the information appears as 3D images.

A mirror device according to the invention is of particular interest if the digital information which the viewer wants to view at the same time as his or her mirror image changes the viewer's appearance. This could be done, for example, by superimposing an image of a selected desired hairstyle on the viewer's real hairstyle or superimposing images of hats, glasses or clothes on the viewer's body. By influencing the brightness of the image, it can be superimposed on the mirror image in such a way that it dominates. Also an image of the back of the head could be shown next to the mirror image. If necessary, a camera would be present for this purpose, which, connected to the electronic display 3.1, produces images of the back of the viewer's head while the viewer is looking in the mirror. Of course, the digital information can also concern any non-pictorial information, which is either viewer-related, such as appointments of the day, or non-viewer-related, such as the weather forecast.

### LIST OF REFERENCE NUMERALS

1 eyes (of the viewer)
1.1 eye lens
1.2 pupil
1.3 retina
2 mirror
2.1 free aperture of the mirror 2
3 optical system
3.0 optical axis
3.0.1 penetration point
3.1 electronic display
3.1′ intermediate image
3.1″ Image in the eyes 1
3.2 lens
3.2.1 first objective
3.2.2 second objective
3.2.3 deflecting element
4.1 sensor
4.2 additional sensor
4.3 brightness sensor
5 computing and control unit
6.1 mark indicating a center
6.2 mark indicating a vertical distance (edge mark)
7.1 first adjustment unit
7.2 second adjustment unit
7.3 third adjustment unit
BP viewer position
a vertical distance (of the viewer position BP from the mirror 2)
h vertical distance (of the viewer position BP from the fixed point FP)
s horizontal distance (of the viewer position BP from the fixed point FP)
FP fixed point (on the mirror 2)
ZBE intermediate image plane
H_{3.2.1}, H_{3.2.1} main planes of the first objective 3.2.1
H_{3.2.2}, H_{3.2.2} main planes of the second objective 3.2.2
F_{3.2.1} object-side focal point of the first objective 3.2.1
F_{3.2.1′} image-side focal point of the first objective 3.2.1
F_{3.2.2} object-side focal point of the second objective 3.2.2
F_{3.2.2′} image-side focal point of the second objective 3.2.2
H_{1.1}, H_{1.1′} main planes of the eye lens 1.1
F_{1.1} object-side focal point of the eye lens 1.1
F_{1.1′} image-side focal point of the eye lens 1.1
AP aperture stop
AP′ aperture stop image

1. A mirror device for simultaneously viewing one's own mirror image and additional information displayed on an electronic display from a viewer position, said device comprising:
a mirror which is partially permeable to visible light and the electronic display arranged on a side of the mirror facing away from the viewer position;
an optical system arranged entirely on the side of the mirror facing away from the viewer position, the optical system comprising the electronic display and a lens arranged along an optical axis and comprising a first objective, a second objective, an aperture stop (AP) and a deflecting element; and
the electronic display configured to be imaged onto an intermediate image plane via the first objective and, via the second objective, the deflecting element and the eye lenses of the eyes of a viewer in the viewer position, or only via the deflecting element and the eye lenses onto their retina;
wherein the intermediate image plane is arranged in a conjugate plane to a plane in which the virtual mirror image of the viewer forms and wherein the aperture stop (AP) is imaged enlarged by the second objective into a plane (E) in front of, in or behind the eyes of the viewer in the viewer position.

2. The mirror device according to claim 1, wherein pupils of the eyes lie in the plane (E) and the aperture stop (AP) is imaged enlarged in such a way that the pupils of the eyes lie within an image of the aperture stop (AP′).

3. The mirror device according to claim 1, wherein the viewer position is determined by three position variables being the vertical distance (a) of the eyes from the mirror, a vertical distance (h), and a horizontal distance (s) of the eyes from an imaginary fixed point (FP) on the mirror.

4. The mirror device according to claim 1, wherein the electronic display is arranged within the focal length of the first objective so that the intermediate image plane is a virtual intermediate image plane.

5. The mirror device according to claim 1, further comprising a first adjustment unit connected to the first objective and the second objective is present, the first objective and the second objective being adjustable so that the intermediate image plane and the aperture stop (AP) are displaceable along the optical axis to adjust a position of the intermediate image plane and the aperture stop (AP) to a change of the vertical distance (a) of the viewer position.

6. The mirror device according to claim 5, further comprising a second adjustment unit connected to the deflecting element, the deflecting element being adjustable in order to adjust the position of a penetration point of the optical axis through the mirror and/or an angular position of the optical axis relative to a perpendicular on the mirror to a change in the horizontal distance (s) and/or the vertical distance (h) of the viewer position.

7. The mirror device according to claim 5, further comprising at least one sensor for determining the vertical distance (a) and a computing and control unit, which is connected to the at least one sensor and the first adjustment unit in order to control the first adjustment unit as a function of detected signals of the at least one sensor.

8. The mirror device according to claim 6, further comprising at least one further sensor for determining the vertical distance (h) and/or the horizontal distance (s), the at least one further sensor being connected to the computing and control unit and the second adjustment unit in order to control the second adjustment unit as a function of detected signals of the at least one further sensor.

9. The mirror device according to claim 1, wherein the optical system is arranged centrally with respect to the mirror in such a way that the optical axis extends vertically up to the deflecting element.

10. The mirror device according to claim 9, wherein the deflecting element is vertically displaceable and/or tiltable about a horizontal axis in order to vertically displace the penetration point of the optical axis and/or to vertically adjust an angular position of the optical axis.

11. The mirror device according to claim 10, wherein the mirror has at least one center mark indicating its center, so that the eyes of the viewer position themselves centrally in front of the mirror in relation to the horizontal distance (s) when guided by the at least one center mark in from of the mirror.

12. The mirror device according to claim 3, further comprising, a third adjustment unit, wherein the mirror device is mounted so as to be vertically suspended and wherein the mirror device is vertically displaceable via the third adjustment unit.

13. The mirror device according to claim 12, wherein the mirror has at least one edge mark indicating a fixed vertical distance from an upper or lower edge of the mirror, so that the viewer, guided by the at least one edge mark, can adjust the mirror device vertically to position the eyes in front of the mirror at the vertical distance (h) regardless of the viewer's height.

14. The mirror device according to claim 1, further comprising a brightness sensor for detecting brightness of ambient light, the brightness sensor being connected to the electronic display to control its radiation intensity.

15. The mirror device according to claim 1, further comprising a second optical system, wherein an intermediate image reproduced together with a second intermediate image in the eyes provides a 3D image of the information.

16. The mirror device according to claim 7, further comprising at least one further sensor for determining the vertical distance (h) and/or the horizontal distance (s), the at least one further sensor being connected to the computing and control unit and the second adjustment unit in order to control the second adjustment unit as a function of detected signals of the at least one further sensor.
